(19) United States
(12) Patent Application Publication
(10) Pub. No.: US 2014/0240560 A1
(43) Pub. Date: Aug. 28, 2014

(54) IMAGING APPARATUS, METHOD FOR CONTROLLING IMAGING APPARATUS AND COMPUTER-READABLE STORAGE MEDIUM

(71) Applicant: CANON KABUSHIKI KAISHA, Tokyo (JP)

(72) Inventor: Akira Tsukuda, Kawasaki-shi (JP)

(73) Assignee: CANON KABUSHIKI KAISHA, Tokyo (JP)

(21) Appl. No.: 14/187,474

(22) Filed: Feb. 24, 2014

(30) Foreign Application Priority Data
Feb. 28, 2013 (JP) 2013-040036

(51) Int. Cl. H04N 5/361

(52) U.S. Cl. CPC H04N 5/361
USPC 348/294

(57) ABSTRACT

In an imaging apparatus, a two-dimensional surface on which imaging elements are arranged has a first region that includes one or more lines, and a second region other than the first region that includes a plurality of lines, each line including a light shielded region that is shielded from light and an effective region other than the light shielded region. The imaging apparatus determines a correction value for use in offset correction for each line in the first region according to the representative value derived with respect to the first region and a first determination method, and determines correction value for use in the offset correction for each line in the second region according to the representative value derived with respect to the second region and a second determination method that is independent from the first determination method.

### BACKGROUND OF THE INVENTION

1. Field of the Invention

The present invention relates to an imaging apparatus, method for controlling imaging apparatus and computer-readable storage medium.

2. Description of the Related Art

In solid-state image sensing devices such as CCD sensors or CMOS sensors, there is a dark current signal that is output even while not emitting light. The effect of this dark current signal on a captured image can be corrected by removing, from the captured image, an image captured while no light is being emitted. Such a dark current includes a component that varies depending on the time, and thus more appropriate correction is possible by obtaining the dark current signal and an image signal while light is being emitted at the same time. In order to do so, a real-time dark current correction method is used in which a part of the solid-state image sensing device is shielded from light to provide a region that is not irradiated with light (optical black region (hereinafter, referred to as a “light shielded region”)), and a dark current signal and an image signal are obtained at the same time.

In the light shielded region, however, a dark current of pixels having a small pixel value is generally read, and thus this region is significantly affected by noise. Also, in a CCD or CMOS sensor, a system-on-chip in a lamination structure can be formed such that a scanning circuit such as a shift register is formed on a solid-state image sensing device, and thus the scanning circuit can be formed directly below or above pixels. In such a case, however, pixels in a predetermined line above or below the scanning circuit may be affected by the heat of the scanning circuit, and the dark current may significantly vary.

In order to eliminate or reduce the effect of noise from the dark current signal, Patent Document 1 (Japanese Patent Laid-Open No. 2006-41935) discloses a method using a smoothing processing, a median processing, or the like. Patent Document 2 (Japanese Patent Laid-Open No. 2004-15712) discloses a method for reducing noise in a dark current by obtaining an average of light shielded regions for each line.

However, in the method disclosed in Patent Document 1, values of dark currents of pixels including a specific line (the specific line is assumed to be a vertical line for the sake of explanation) that significantly differs from other light shielded pixel lines due to the effect of the heat are smoothed in a lateral direction by an averaging processing or a median processing. Therefore, the dark current value of the specific line collapses, and it is not possible to correctly assume the dark current in the specific line, which may cause the situation in which appropriate dark current correction is not possible with respect to the pixel value in the specific line. Also, in the method disclosed in Patent Document 2, since smoothing is not performed in a lateral direction, variation due to noise in the lateral direction may directly be added to the dark current value.

### SUMMARY OF THE INVENTION

In view of the above-described problem, an embodiment of the present invention discloses a configuration that enables appropriate dark current correction, even if a specific line has a dark current value that significantly differs from other lines.

According to one aspect of the present invention, there is provided an imaging apparatus comprising an imaging element in which a plurality of pixels are arranged on a two-dimensional surface, the two-dimensional surface having a first region that includes one or more lines, and a second region other than the first region that includes a plurality of lines, each line including a light shielded region that is shielded from light, and an effective region other than the light shielded region, the imaging apparatus further comprising: a derivation unit configured to derive, for each line, a representative value based on pixel values in the light shielded region; a first determination unit configured to determine, based on the representative value derived with respect to the first region, a correction value for use in an offset correction for each line in the first region; and a second determination unit configured to determine, based on the representative value derived with respect to the second region, a correction value for use in the offset correction for each line in the second region.

Also, according to another aspect of the present invention, there is provided a method for controlling an imaging apparatus including an imaging element in which a plurality of pixels are arranged on a two-dimensional surface, the two-dimensional surface having a first region that includes one or more lines, and a second region that is other than the first region and includes a plurality of lines, each line including a light shielded region that is shielded from light, and an effective region other than the light shielded region, the method comprising: a derivation step of deriving, for each line, a representative value based on pixel values in the light shielded region; a first determination step of determining, based on the representative value derived with respect to the first region, a correction value for use in an offset correction for each line in the first region, the first determination step being performed according to a first determination method; and a second determination step of determining, based on the representative value derived with respect to the second region, a correction value for use in the offset correction for each line in the second region, the second determination step being performed according to a second determination method that is independent from the first determination method.

Further features of the present invention will become apparent from the following description of exemplary embodiments (with reference to the attached drawings).

### BRIEF DESCRIPTION OF THE DRAWINGS

FIG. 1 is a diagram illustrating an example of a functional configuration of an imaging apparatus according to a first embodiment.

FIG. 2 is a diagram illustrating a part of a solid-state image sensing device according to the first embodiment.

FIGS. 3A to 3D are diagrams illustrating examples of methods for deriving functions according to the first embodiment.

FIG. 4 is a flowchart illustrating an example of processing of the imaging apparatus according to the first embodiment.

FIG. 5 is a flowchart illustrating an example of processing of an imaging apparatus according to a second embodiment.

FIG. 6 is a diagram illustrating an example of a functional configuration of an imaging apparatus according to a third embodiment.

FIG. 7 is a flowchart illustrating an example of processing of the imaging apparatus according to the third embodiment.

### DESCRIPTION OF THE EMBODIMENTS

Hereinafter, embodiments of the present invention will be described in detail with reference to the attached drawings.

### First Embodiment

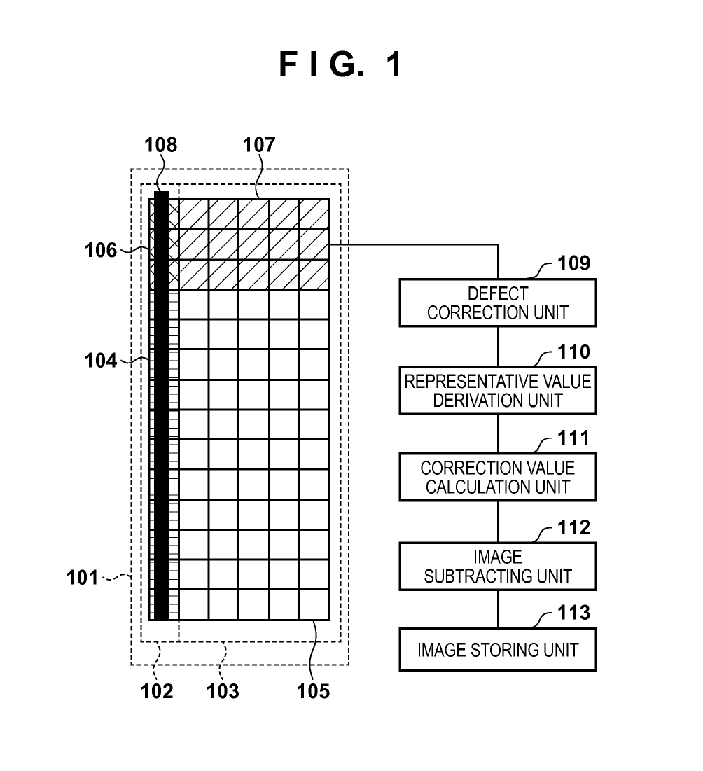

A functional configuration of an imaging apparatus according to a first embodiment is described with reference to FIG. 1. The imaging apparatus according to the first embodiment includes a solid-state image sensing device 101 that is constituted by a plurality of pixels each having a photoelectric conversion element. The solid-state image sensing device 101 includes an imaging element in which a plurality of pixels are arranged on a two-dimensional surface. This two-dimensional surface of the solid-state image sensing device 101 has a first region 102 that includes one or more lines, and a second region 103 other than the first region that includes a plurality of lines. Also, each line in the first region and the second region has pixels in a light shielded region (optical black region) that is shielded from light, and pixels in an effective region other than the light shielded region. In the present embodiment, as shown in FIG. 1, the two-dimensional surface of the solid-state image sensing device 101 includes the first region 102 and the second region 103 that extend in a vertical direction, and a light shielded region that extends over these regions (with a width of three pixel lines in FIG. 1). The first region 102 includes light shielded pixels 106 that are shielded from light (belonging to a light shielded region), and effective pixels 104 that are not shielded from light (other than the light shielded region). Similarly, the second region 103 includes light shielded pixels 107 that are shielded from light (belonging to the light shielded region), and effective pixels 105 that are not shielded from light (other than the light shielded region).

A vertical scanning circuit 108 is a circuit that controls vertical scanning in the solid-state image sensing device 101, and is arranged along the line in the vertical direction in the first region. A defect correction unit 109, a representative value derivation unit 110, a correction value calculation unit 111, and an image subtracting unit 112 that are included in the imaging apparatus will be described later. An image storing unit 113 is generally provided in a storage medium externally of the solid-state image sensing device 101. Note that the defect correction unit 109, the representative value derivation unit 110, the correction value calculation unit 111, and the image subtracting unit 112 may also be realized using an external image processing apparatus such as a computer.

Due to the effect of heat of the vertical scanning circuit 108 formed directly below or above the pixels, the pixels of the first region 102 may have the dark current values significantly different from those of the pixels in the second region 103 arranged at a sufficient distance from the vertical scanning circuit. Note that the effect of heat of the vertical scanning circuit 108 is limited only to a narrow region, and drastically decreases as a distance from the vertical scanning circuit increases. In the present embodiment, it is assumed that the effect of the heat appears only in one line immediately close to the vertical scanning circuit 108. Therefore, in the present embodiment, one pixel line immediately close to the vertical scanning circuit 108 is assumed to be the “first region”. Note that, in the case where the effect of the heat of the vertical scanning circuit is not limited to the pixels immediately close thereto, the first region 102 may include the pixels immediately close to the vertical scanning circuit 108 and a plurality of pixel lines adjacent to those pixels. For example, the first region may include the pixel line immediately close to the vertical scanning circuit 108 and the pixel lines closely adjacent thereto.

The defect correction unit 109 corrects a defect occurred to an image obtained by the solid-state image sensing device 101. A defect occurred in the light shielded region is corrected by interpolation using a method that will be described later. The representative value derivation unit 110 derives, for each vertical line, a representative value of pixel values of pixels in the light shielded region that belong to the same vertical line of the imaging element. Such a representative value may be, for example, an average or a median in each vertical line in the light shielded region. Note that if each vertical line includes only one light shielded pixel, the pixel value of the light shielded pixel in each line can be used as a representative value.

With respect to the representative value in the light shielded region obtained by the representative value derivation unit 110, the correction value calculation unit 111 determines a correction value using the position of the light shielded region and a function indicating a tendency of the representative values. There are methods using the following functions as such a function for determining a correction value:
a straight line taking as an output a fixed value representing a representative value for positions in the vertical lines or the lateral lines;
a moving average of representative values;
a median neighboring representative value;
a fitting curve of representative values (such as a least-square method, the Bezier curve, or the like), and the like.

Although the above-described methods are described in the present embodiment, another curve or function may be derived in order to determine a correction value. The method for determining a correction value will be described further in detail later.

The image subtracting unit 112 performs offset correction by subtracting the result of the processing by the representative value derivation unit 110 and the correction value calculation unit 111 from the image output by the solid-state image sensing device 101. The image subtracting unit 112 performs the subtraction for each line, whereas the correction value calculation unit 111 uses independent methods for determining a correction value to be used for the subtraction with respect to regions having different tendencies of dark current values. That is, the correction value calculation unit 111 performs, with respect to the first region 102, first determination processing in which a first determination method is used for determining a correction value based on a representative value. Whereas, the correction value calculation unit 111 performs, with respect to the second region 103, second determination processing in which a second determination method that is independent from the first determination method is used for determining a correction value based on a representative value. In the present embodiment, the correction value calculation unit 111 determines a correction value by subtracting, for each line, a representative value (obtained by the representative value derivation unit 110) from the pixel value of a pixel in the first region 102. That is, the representative value of each line is used as a correction value of each line. In the second region 103, on the other hand, the correction value calculation unit 111 determines a correction value with the use of a function for determining a correction value of a line based on a plurality of representative values including representative values of lines adjacent thereto. The image subtracting unit 112 performs the offset correction by subtracting, from pixel values of pixels in respective lines of the first region 102 and the second region 103, the correction values of the respective lines of the regions determined by the correction value calculation unit 111. The image subtraction method will be described in detail later. The image storing unit 113 stores the corrected image. Note that the image storing unit 113 may be a general-purpose storage medium such as a flash memory or a hard disk.

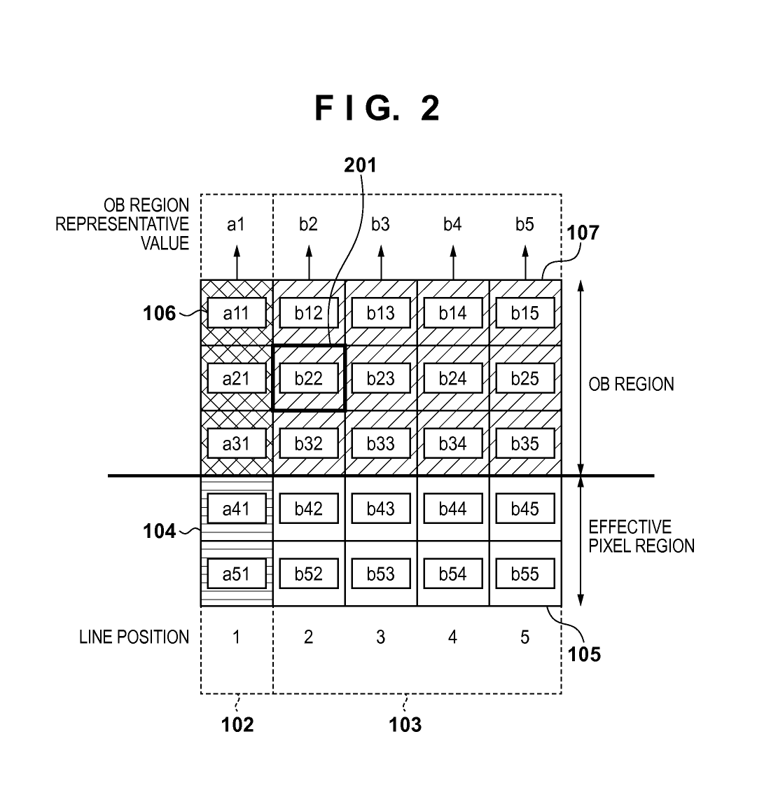

Next, aspects of the defect correction, the correction value determination, and the image subtraction according to the first embodiment will be described further in detail with reference to FIG. 2. As described above, the first region 102 is constituted by the effective pixels 104 and the light shielded pixels 106, and the second region is constituted by the effective pixels 105 and the light shielded pixels 107. Also, the positions of lines are defined as line positions 1, 2, . . . 5 from left to right. A combination of an alphabet letter and a numeral indicated on each pixel, that is, all, a21, b12, or the like, shows a pixel value of each pixel. Also, a representative value for each line of the light shielded region that is obtained by the representative value derivation unit 110 is defined as a1, b2, or the like. Also, a defect pixel 201 that has a pixel value b22 has a pixel value significantly different from those of adjacent pixels in the light shielded region. Note that, in FIG. 2, light shielded pixels and effective pixels are arranged in five rows and five lines, but they may be arranged, of course, in any numbers of rows and lines within a range in which no logical inconsistency is brought about.

First, the defect correction method performed in the defect correction unit 109 is described. In FIG. 2, the defect pixel 201 is present in the second region 103. Accordingly, a corrected pixel value of the defect pixel 201 is obtained by the following equation:

b22=(b12+b32+b23)/3 (1),

using pixels adjacent to the defect pixel 201 excluding the pixel value (a21) in the light shielded region of the first region 102, and correction is performed using the corrected pixel value. Since the pixel value in the light shielded region of the first region 102 that has a dark current value significantly different from those in the second region 103 is excluded, a pixel value close to other pixel values in the light shielded region of the second region 103 is obtained as a correction result.

Also, in the case where, in the second region 103, representative values of the light shielded pixels significantly differ by line, the following equation is used:

b22=(b12+b32)/2 (2),

and the pixel value of the light shielded pixel belonging to another line is not used.

Note that in the case where no defect correction in the light shielded region is performed by the defect correction unit 109, the representative value derivation unit 110 may calculate the representative value using also the following equation:

b2=(b12+b32)/2 (3),

excluding the pixel value (b22) of the defect pixel. Note that the description above shows the case where the representative value is an average, but even in the case where a calculated value such as a median is used as the representative value, it is also possible to obtain a representative value without using the pixel value of the defect pixel.

According to the above-described methods, it is possible to perform, in the light shielded region of the second region 103, the defect correction using pixel values of the light shielded pixels 107 that have similar dark current values, thereby making highly accurate defect correction possible.

Next, the function derivation performed in the correction value calculation unit 111 is described in detail. Note that the term “an output of a function” used here refers to an output result obtained by substituting a line position in a function. In the case where a curve obtained based on representative values by fitting is used as a function, an output result is obtained by substituting a line position in the obtained curve. In the following detailed description, specific examples are shown appropriately.

The following describes, as an aspect of a function indicating a tendency, a method for obtaining a straight line taking, as an output, a fixed value representing a representative value for all positions in vertical lines or lateral lines. In the case where the fixed value is, for example, an average, the following processing will be performed. First, an average of the representative values b2, b3, b4, and b5 obtained by the representative value derivation unit 110 is obtained ((b2+b3+b4+b5)/4). Note that when obtaining an average, it is preferable to exclude representative value a1 of the light shielded region that has a dark current value different from other values in light shielded region. Next, a function indicating a tendency is obtained by calculating the following equation:

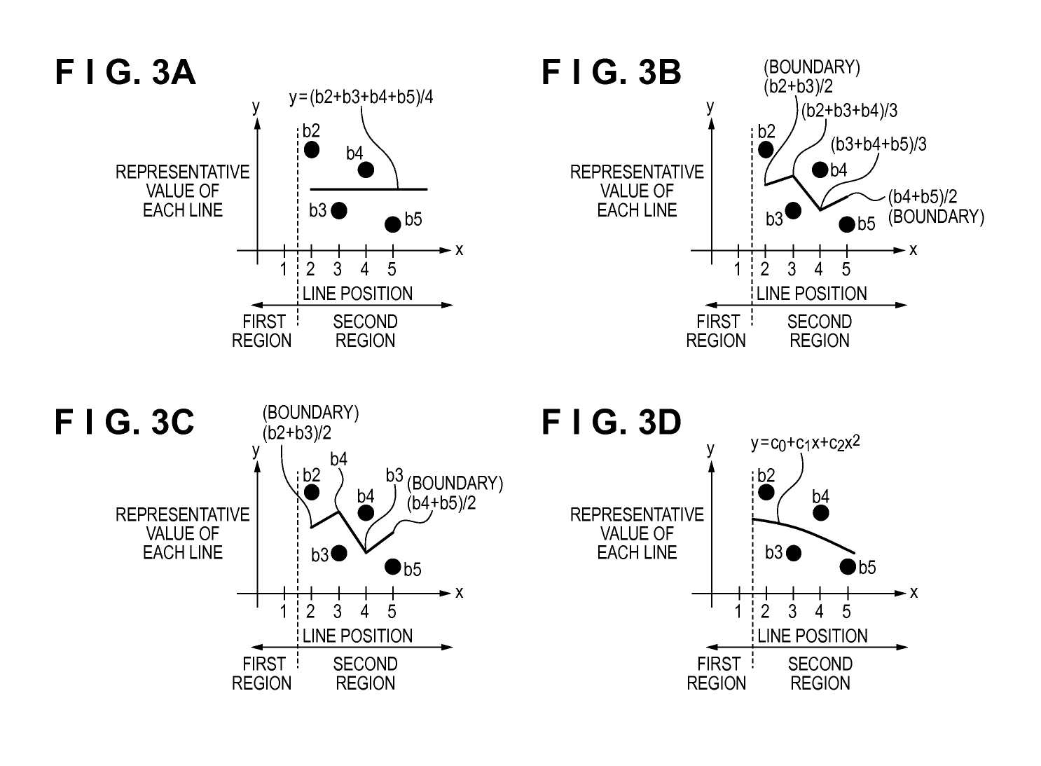

y=(b2+b3+b4+b5)/4 (4)

where the line positions in the light shielded region are denoted on a horizontal axis (x axis) and an average of the lines is denoted on a vertical axis (y axis). In this case, an output of a function is a value indicated in the right side member of the equation (4) irrespective of the line positions. An aspect of this method for determining a correction value is shown in FIG. 3A. In this case, a straight line is used as a function. Note that although, in the above-described aspect, an average of representative values is obtained for deriving such a function, that is, a straight line, the present invention is not limited to such an aspect. For example, a median value of representative values may be set as the right side member of the function (4) indicating a tendency of the representative values. It is also possible, instead of obtaining a representative value, first to obtain an average of pixel values of twelve light shielded pixels in total from b12 to b35, and then to set this average as the right side member of the function (4) indicating a tendency. It is also possible first to obtain a median of the pixel values of twelve light shielded pixels in total from b12 to b35 and then to set this median as the right side member of the function (4) indicating a tendency.

Then, as another aspect of a function indicating a tendency, a method for calculating a moving average of representative values is described. This method is an aspect of smoothing of a curve drawn by representative values. If calculating a moving average, a method for calculating an average of a plurality of representative values is used, the plurality of representative values including, for example, a representative value of a target line and representative values of lines (adjacent line) adjacent to the target line, or other method may be used. Depending on the required level of smoothing, a representative value of a line other than adjacent lines of the target line may be used for calculation, or only one of representative values of adjacent lines that is left or right adjacent to the target line may be used for calculation. Also, a boundary of a region is appropriately processed by a method that will be described below.

A further specific example will be described with reference to FIGS. 2 and 3B. In this example, an average of the representative value of the target line and representative values of adjacent lines of the target line is obtained, in order to obtain a function indicating a tendency of the representative values. For example, the value at a line position 3 of a function indicating a tendency is indicated by (b2+b3+b4)/3 using representative values b2 and b4 of the line positions 2 and 4, in addition to the own representative value b3. Note that when obtaining a value at a boundary of the region, for example, a line position 5 of the function indicating a tendency, (b4+b5)/2 is calculated that uses the representative value b5 at the line position 5 and the representative value b4 of the left adjacent line.

In this way, values of lines at the line positions 2 to 5 of the function indicating a tendency are calculated, the results are as follows:

The line position 2 (boundary): (b2+b3)/2 (5)

The line position 3 (not a boundary): (b2+b3+b4)/3 (6)

The line position 4 (not a boundary): (b3+b4+b5)/3 (7)

The line position 5 (boundary): (b4+b5)/2 (8)

Note that, for the calculation of an output of a function indicating a tendency of the representative values, like the above calculation, it is preferable to perform the calculation without the representative value a1 of the line that has a different dark current value.

As an output of the above-described function, for example, an output at the line position 2 is obtained by the equation (5) and an output at the line position 3 is obtained by the equation (6). The aspect of outputs derived using the above-described function is shown in FIG. 3B.

The following describes a method for calculating a median of neighboring representative values, as an aspect of yet another function. This method is one aspect of smoothing of a curve drawn by representative values. In order to obtain a median, a median of a representative value of a target line and representative values of adjacent lines of the target line, for example, are calculated. Similar to the method for calculating a moving average, depending on the required level of smoothing, a representative value of a line other than adjacent lines of the target line may be used for calculation, or one of representative values of adjacent lines that is left or right adjacent to the target line may be used for calculation. Also, a boundary of a region is appropriately processed.

A specific example will be described with reference to FIGS. 2 and 3C. The sizes of the values are given as b2>b4>b3>b5, as shown in FIG. 3C. In this example, a median of a representative value of a target line and representative values of adjacent lines of the target line is obtained, in order to obtain a curve indicating a tendency. For example, the value at the line position 3 in a curve indicating a tendency is obtained by comparing the own representative value b3 with the representative values b2 and b4 of the line positions 2 and 4, and the median b4 is set as the value at the line position 3. When the value at a boundary of the region, such as the line position 5 in the curve indicating a tendency, is obtained, the representative value b5 at the line position 5 and the value of the representative value b4 of the line left adjacent to the boundary are used. In this example, since only two values are compared with each other, an average (b4+b5)/2 is obtained as an alternative for a median, and this average is set as the value at the line position 5 of the function indicating a tendency.

In this way, values of lines at the line positions 2 to 5 of the curve indicating a tendency are calculated, the results are as follows:

The line position 2 (boundary): (b2+b3)/2 (9)

The line position 3 (not a boundary): med(b2,b3,b4)=b4 (10)

The line position 4 (not a boundary): med(b3,b4,b5)=b3 (11)

The line position 5 (boundary): (b4+b5)/2 (12).

Note that med( ) is a function for extracting a median. Also, if calculating a moving average or a dark current value, the calculation is preferably be performed without using the representative value a1 of the first region 102.

An output of the function at the line position 2, for example, is an average of b2 and b3, as shown by the equation (9), and an output at the line position 3 is “b4”, as shown in the equation (10). The aspect of this method for deriving a curve is shown in FIG. 3C.

The following describes a method for calculating a fitting curve of representative values, as an aspect of yet another function. In order to obtain a fitting curve, a least-square method is used. Note that it is preferable to obtain a fitting curve without using representative values of the line that belongs to the first region 102.

Hereinafter, a specific example will be described with reference to FIGS. 2 and 3D. The least-square method is used for obtaining a fitting curve. In the least-square method, the representative values b2, b3, b4, and b5 of the pixels of the light shielded region in the second region 103 in FIG. 2 are plotted with line positions on a horizontal axis (x axis) and representative values of lines on a vertical axis (y axis). Then, a curve indicating a tendency of the representative values is obtained by the least-square method. The least-square method uses an order that is sufficient for indicating a tendency of the representative values. FIG. 3D shows an example using a quadratic expression:

y=c₀+c₁x+c₂x² (13)

where c₀, c₁, and c₂ are coefficients of the zero-degree, the first-degree, and the second-degree obtained by the least-square method.

As described above, in the fitting curve obtained by the least-square method, an output result of the function is obtained by substituting a line position in the equation (13). For example, an output at the line position 2 is obtained by using the equation (13), that is, c₀+c₁×2+c₂×2². The description on the curve derivation method has thus been given.

Hereinafter, the subtraction method performed by the image subtracting unit 112 will be described in detail. In the description, it is assumed in FIG. 2 that corrected pixel values of pixels having pixel values aij and bij are respectively a′ij and b′ij. For example, the corrected pixel value of a31 is a′31.

In the method for obtaining, as a function, a straight line taking as an output a fixed value representing a representative value for all positions in vertical lines or lateral lines, if the fixed value is an average, pixel values obtained as the result of the subtraction processing by the image subtracting unit 112 are as follows:

a′i1=ai1−a1 (14)

b′ij=bij−(b2+b3+b4+b5)/4 (15)

where i=1, 2, 3, 4, and 5, and j=2, 3, 4, and 5.

Also, in the method using a function obtained by calculating a moving average of representative values, pixel values obtained as the result of the subtraction processing are as follows:

a′i1=ai1−a1 (16)

b′i2=bi2−(b2+b3)/2 (17)

b′i3=bi3−(b2+b3+b4)/3 (18)

b′i4=bi4−(b3+b4+b5)/3 (19)

b′i5=bi5−(b4+b5)/2 (20)

where i=1, 2, 3, 4, and 5.

Also, in the method using a function obtained by calculating a median of neighboring representative values, subtracted pixel values are as follows:

a′i1=ai1−a1 (21)

b′i2=bi2−(b2+b3)/2 (22)

b′i3=bi3−b4 (23)

b′i4=bi4−b3 (24)

b′i5=bi5−(b4+b5)/2 (25)

where i=1, 2, 3, 4, and 5.

Further, in the method using a function obtained by calculating a fitting curve of representative values, pixel values obtained as the result of the subtraction processing are as follows:

a′i1=ai1−a1 (26)

b′i2=bi2−(c₀+c₁×2+c₂×2²) (27)

b′i3=bi3−(c₀+c₁×3+c₂×3²) (28)

b′i4=bi4−(c₀+c₁×4+c₂×4²) (29)

b′i5=bi5−(c₀+c₁×5+c₂×5²) (30)

where i=1, 2, 3, 4, and 5, and c₀, c₁, and c₂ are respectively coefficients.

Note that, although in the present description, the subtraction is performed also in the light shielded region, the subtraction is not necessarily performed in the light shielded region thereby allowing a reduction in the amount of processing. The subtraction methods performed by the image subtracting unit 112 have thus been described in detail.

Although a method for determining a correction value to be used for correcting each pixel using any of the functions has described in detail, characteristics of the above-described method for deriving a correction value using a function are finally described. First, in the method for obtaining a straight line taking as an output a fixed value representing a representative value for all positions in vertical lines or lateral lines, the simplest algorithm is used and thus fast operation is possible. On the other hand, if a dark current value of the solid-state image sensing device 101 has shading, it is possible to reduce the shading by using any one of the methods for calculating a moving average of representative values, for calculating a median of neighboring representative values, for obtaining a fitting curve of the representative values. In the situation in which, if calculating a moving average or a median, smoothing is not so sufficient that an artifact occurs, a method for obtaining a fitting curve of the representative values is efficient.

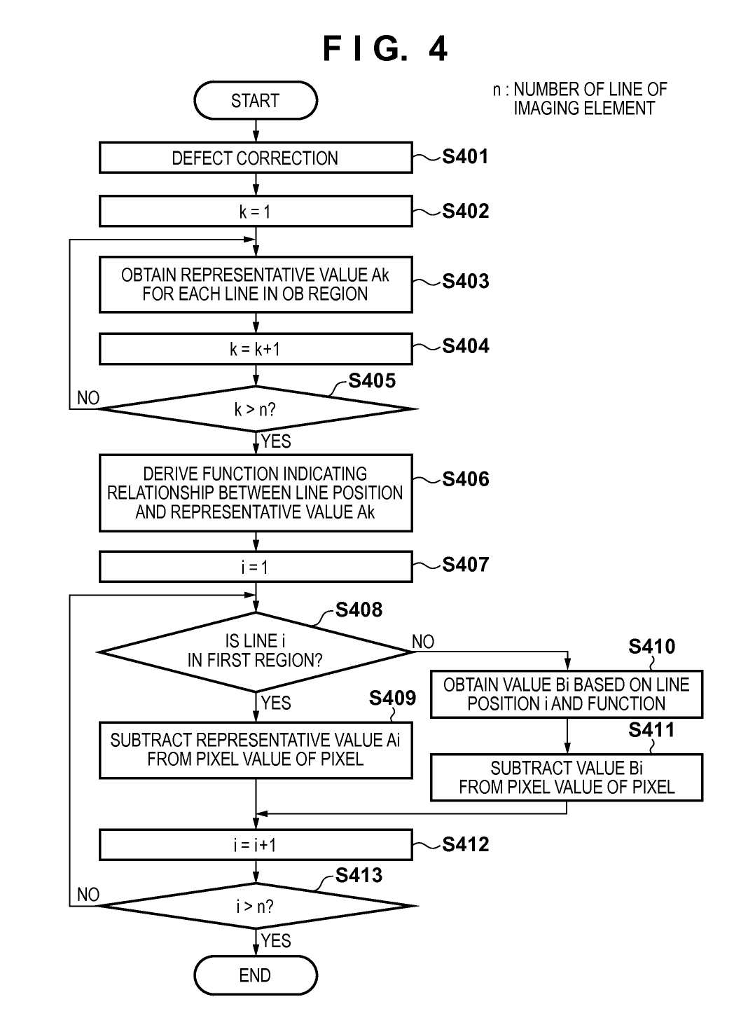

Hereinafter, the flow of processing (in particular, image correction processing with respect to a dark current signal) of the imaging apparatus according to the first embodiment is described with reference to FIG. 4. First, in step S401, the defect correction unit 109 performs image defect correction in the light shielded region. The method of defect correction is as described above. Note that it is assumed that it is known in advance which pixel is a defect pixel by an inspection before shipping and the pixel is registered in the defect correction unit 109.

Next, in steps S402, S403, S404, and S405, the representative value derivation unit 110 obtains, for each line, a representative value Ak in the light shielded region. Here, it is assumed that there are n lines (n is an integer). In the case of FIG. 2, since there are five vertical lines, n=5 is used to execute processing in step S403 (calculation of a representative value in the light shielded region) with respect to five vertical lines, and a representative value for each line is calculated. Examples of the calculation of a representative value include the above-described calculation of an average of pixel values in each line, and extraction of a median of pixel values for each line.

Next, in step S406, the correction value calculation unit 111 derives a function indicating the relationship between the line position of a line and the representative value Ak in the light shielded region. The derived function may be, as described above,
a function indicating a straight line taking as an output a fixed value representing a representative value for positions in the vertical line or the lateral line;
a function indicating a moving average of representative values;
a function indicating a median neighboring representative value;
a function indicating a fitting curve of representative values; and the like. Note that, as described above, when obtaining a function, the function is preferably obtained without using the representative value obtained based on the light shielded pixels 106 in the light shielded region of the first region 102. Also, in the configuration using a moving average or a median, the processing for deriving a moving average or a median does not particularly need to be performed, but a user can set the number of representative values in the extraction of a moving average or a median.

Next, in steps S407 to S413, the correction value calculation unit 111 determines a value (correction value) to be subtracted for each line, and the image subtracting unit 112 subtracts the determined value from the pixel value of a pixel in each line. Here, if the target line i is in the first region 102, the correction value calculation unit 111 determines a correction value using the first determination method. That is, the correction value calculation unit 111 determines the representative value Ai of the line i as a correction value to be subtracted from a pixel value (S408 and S409). Accordingly, the image subtracting unit 112 executes offset correction by subtracting the representative value Ai from the pixel value of a pixel belonging to the line i. On the other hand, if the line i does not belong to the first region 102 but to the second region 103, the correction value calculation unit 111 determines a correction value using the second correction method. That is, the correction value calculation unit 111 obtains an output Bi at the position i in the line based on the function derived in step S406 (S408 and S410). Then, the image subtracting unit 112 subtracts the output Bi obtained in step S410 from the pixel value of a pixel belonging to the line i (S411). This procedure is performed for all the lines in the imaging element (S412 and S413).

In the above-described method, a dark current value of each pixel is corrected. According to the method, since values to be subtracted are separately obtained for the first region 102 and the second region 103 that have different dark current values, it is possible to perform more accurate dark current correction without smoothing the dark current value of the first region 102 affected by the heat of the vertical scanning circuit 108. Therefore, according to the first embodiment, even if the imaging element includes a specific line that significantly differs from other light shielded pixel lines, it is possible to reduce the effect of noise of the dark current, and to perform appropriate correction of a dark current caused by shielding the specific line and other lines from light.

Note that in the case where the first region 102 includes a plurality of lines, and the first region 102 and the second region 103 have substantially the same size, use of the method in the first embodiment may cause an artifact, similarly to the case of Patent Document 2. In such case, it is possible to suppress an occurrence of an artifact by using a method of a second embodiment that will be described later. In other words, according to the present invention, even if a specific line has a dark current value that is significantly different from other lines, it is possible to perform appropriate dark current correction.

### Second Embodiment

According to the first embodiment, in the first region 102, the processing for deriving a function is not performed and a representative value of each line is subtracted from the pixel value of each pixel. However, in the case where, for example, a plurality of lines belong to the first region 102, and the first region 102 has substantially the same size as that of the second region 103, an artifact may occur in the first region 102 due to the departure of the representative value caused due to the reduced number of pixels in the light shielded region. The second embodiment is such that derivation of a function is performed also in the first determination method for determining a correction value in the first region 102, and output values of the function are subtracted from pixel values of the first region 102, thereby achieving a reduction in an artifact occurred in the first region 102. Note that descriptions redundant with those of the first embodiment are omitted.

The functional configuration of the second embodiment is similar to that of the first embodiment. However, in the second embodiment, the first region 102 is not limited to pixels of the line on which the vertical scanning circuit 108 is directly arranged, and is constituted by pixels belonging to a several number of vertical lines in the vicinity of the vertical scanning circuit 108. Also, the correction value calculation unit 111 according to the second embodiment can derive functions independently for the first region 102 and the second region 103, and determine correction values.

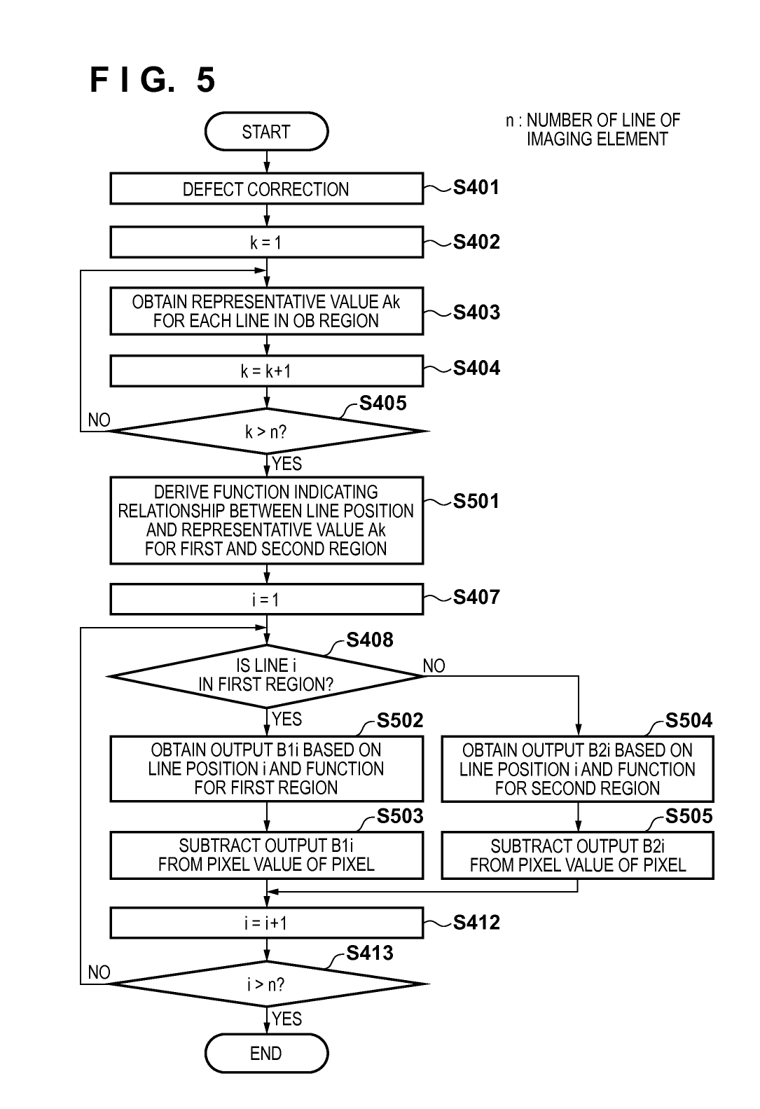

Hereinafter, a flow of processing (in particular, image correction processing with respect to a dark current signal) according to the second embodiment is described with reference to FIG. 5. In FIG. 5, steps S401 to S405, S407, S408, S412, and S413 are the same processing as those in the first embodiment (FIG. 4).

In step S501, the correction value calculation unit 111 obtains correction values in the first region 102 and the second region 103 with the use of functions independently indicating the relationship between a line position k and a representative value Ak. That is, although a function with respect to the second region 103 is derived in step S406 in the first embodiment, functions for both the first region 102 and the second region 103 are derived in the second embodiment.

The functions for the first region 102 and the second region 103 are derived using the methods described in the first embodiment. Note that the first function and the second function applied to the first region 102 and the second region 103 may be of different types, or of the same type. For example, a fitting curve may be used as the first function for the first region 102, and a moving average may be used as the second function for the second region.

In steps S408, S502 to S505, S412, and S413, the image subtracting unit 112 subtracts output values of a function from pixel values in both the first region 102 and the second region 103. In the first embodiment, the correction value calculation unit 111 determines, in step S409, a representative value for each line in the first region 102 as a correction value, whereas, in the second embodiment, an output value of a first function for the first region 102 obtained in step S501 is determined as a correction value. Also, in the second region 103, the correction value calculation unit 111 determines, similarly to the first embodiment, an output value of the second function for the second region 103 as a correction value. Note that the subtraction processing of the image subtracting unit 112 is performed with respect to each region as described in the first embodiment.

As described above, according to the second embodiment, output values of a function are subtracted from respective pixel values also in the first region 102, it is thus possible to suppress an occurrence of an artifact in the first region 102 in contract to the case of Patent Document 2. If the first region 102 does not include a sufficient number of lines for deriving a curve, the method in the first embodiment is used instead of that of the second embodiment.

### Third Embodiment

In the imaging apparatus according to the first embodiment or the second embodiment, an artifact is likely to occur when obtaining a value that is to be subtracted and used for correcting a dark current signal with the use of the method of the first embodiment or the second embodiment, if there is a large difference among dark current values of lines. In such a case in which there is a large difference among dark current values of lines, an image having reduced artifact may be obtained rather by subtracting representative values for all the lines irrespective of in the first region 102 or the second region 103. The third embodiment describes a configuration for solving the above described problem.

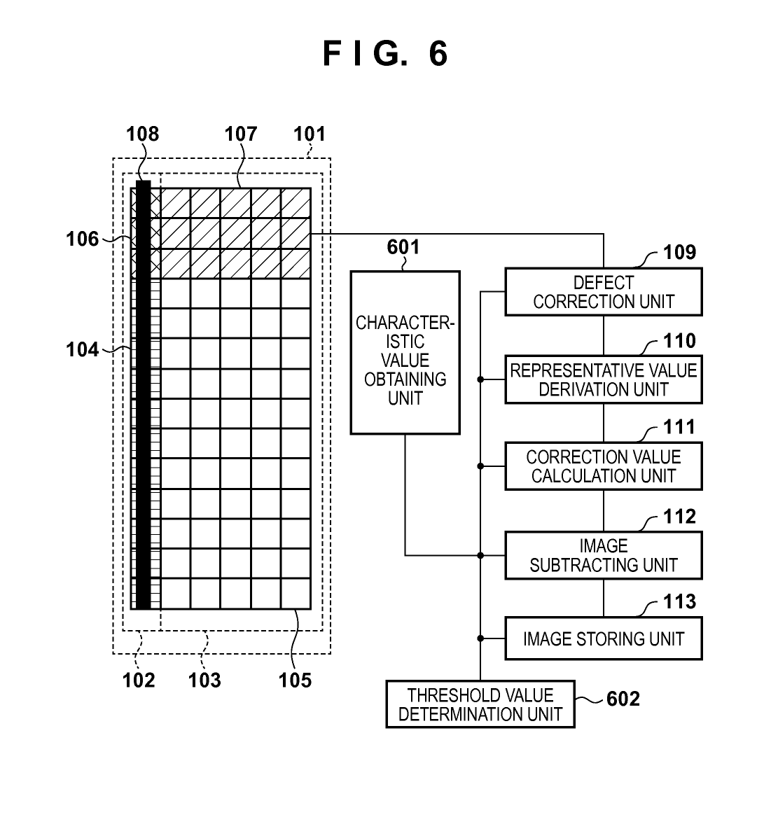

Hereinafter, a functional configuration according to the third embodiment will be described with reference to FIG. 6. Note that descriptions redundant with those of the first embodiment or the second embodiment are omitted. In FIG. 6, in addition to the configurations of the first embodiment and the second embodiment (FIG. 1), a characteristic value obtaining unit 601 and a threshold value determination unit 602 are provided. In the third embodiment, based on the comparison result between the characteristic value and the threshold value obtained by these constituent components, processing for dark current correction is performed depending on the situation. Note that, in the present embodiment, the characteristic value is a variation (for example, a difference or a standard deviation) between representative values in the first region 102 and the second region 103, or a variation (for example, a difference or a standard deviation) between representative values in the second region 103. The characteristic value may also be a value calculated based on, for example, a time elapsed since the imaging apparatus was activated, temperatures of the imaging apparatus or pixels, pixel values in the light shielded region, or the like.

The characteristic value obtaining unit 601 obtains information necessary for calculating a characteristic value, and calculates, based on the information, the characteristic value. In the case where, for the calculation of a characteristic value, a time elapsed since the imaging apparatus was activated, or temperatures of the imaging apparatus or pixels is used, a timer for monitoring the elapsed time, or a thermometer for monitoring the temperature is used as the characteristic value obtaining unit 601. On the other hand, in the case where pixel values and/or representative values in the light shielded region are used for calculating a characteristic value, the characteristic value obtaining unit 601 is directly connected to the solid-state image sensing device 101, the representative value derivation unit 110, and the like, and calculates a characteristic value based on the values obtained from those constituent components. The present embodiment describes the aspect in which a difference between representative values in the first region 102 and the second region 103, or a difference between representative values in the second region 103 is used as a characteristic value. In the case where a characteristic value other than a value calculated based on the representative values, such as a temperature, is used, the temperatures in the first region and the second region, or the temperature in the second region may be used.

Based on the characteristic value obtained by the characteristic value obtaining unit 601, the threshold value determination unit 602 determines processing to be performed. The threshold value determination unit 602 is connected to the defect correction unit 109, the representative value derivation unit 110, the correction value calculation unit 111, the image subtracting unit 112, and the image storing unit 113, and issues, based on the comparison result between the characteristic value and a threshold value, instructions relating to processing to be performed respectively in the first region 102 and the second region 103.

The contents of the processing are, for example, as follows:
(1) In the first region 102, a representative value of the light shielded region is subtracted, for each line, from the corresponding pixel value, and in the second region 103, an output value of a function is subtracted from the corresponding pixel value (first embodiment);
(2) In the first region 102, an output value of a function derived with respect to the first region 102 is subtracted from the corresponding pixel value, and in the second region 103, an output value of a function derived with respect to the second region 103 is subtracted from the corresponding pixel value (second embodiment);
(3) In both the first region 102 and the second region 103, a representative value for each line is subtracted from the pixel value of the effective pixel region that belongs to the corresponding line;
(4) In both the first region 102 and the second region 103, output values of the same function are subtracted from the corresponding pixel values;
(5) Correction using the light shielded region is not performed; and the like.

Note that in the case of (5) in which correction using the light shielded region is not performed, an average of pixel values of an image differs, by a dark current component, from that in the case where such correction is performed. Therefore, in the case where correction using the light shielded region is not performed, offset correction is separately performed on the entire image, or offset correction is performed on the light shielded region. In the case where offset correction is separately performed on the entire image, an offset image that was corrected by light shielding, and an offset image that was not corrected by light shielding are prepared. Then, the offset correction can be performed using the offset image that was corrected by light shielding when performing correction by light shielding, or the offset image that was not corrected by light shielding when not performing correction by light shielding.

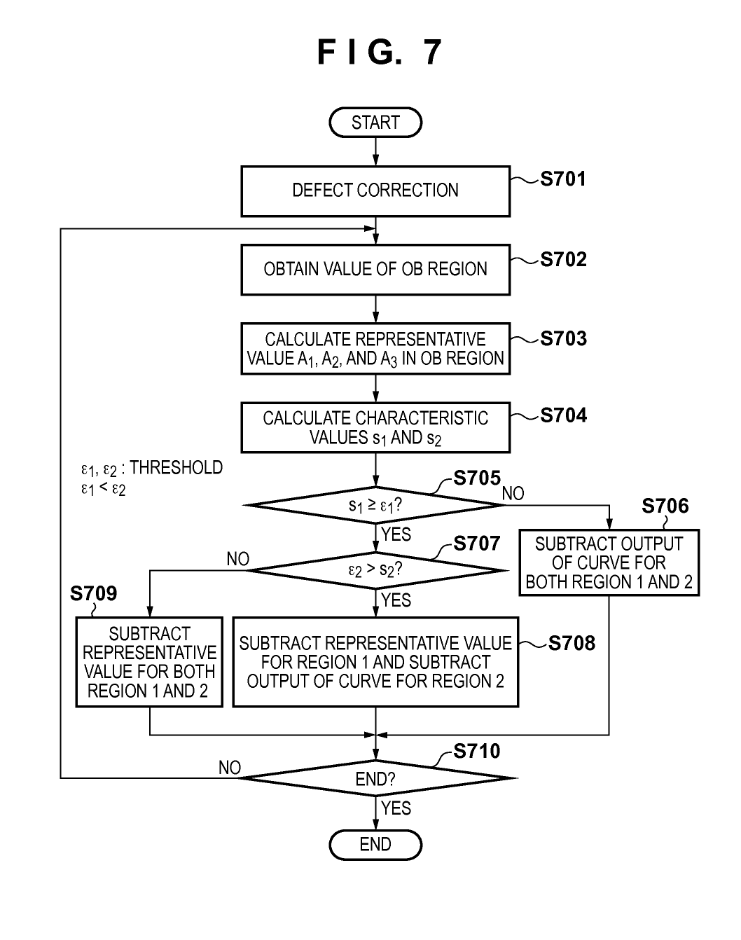

Hereinafter, a flow of processing according to the third embodiment will be described further in detail with reference to FIG. 7. Note that the following will describe the case where a pixel value (representative value) of the light shielded region is used as a characteristic value. In FIG. 7, a region 1 corresponds to the first region 102 described with reference to the first embodiment, the second embodiment, and the like, and the region 2 corresponds to the second region 103 described with reference to the first embodiment, the second embodiment, and the like.

In step S701, the defect correction unit 109 performs defect correction. According to the present embodiment, since pixel values of a light shielded region are used for calculating a characteristic value, it is preferable to perform defect correction at least in the light shielded region.

Next, in step S702, the representative value derivation unit 110 obtains pixel values of a light shielded region of an image, and calculates representative values in step S703. Accordingly, with respect to three lines 1, 2, and 3 of the light shielded region, representative values A₁, A₂, and A₃ are obtained. Here, A₁ is a representative value of a line selected from the light shielded region of the first region 102, and A₂ and A₃ are representative values selected from lines in the light shielded region of the second region 103. Also, A₂ and A₃ are assumed to be representative values of different lines. Here, the representative values of the light shielded region to be obtained are not necessarily only the representative values of three lines. If a method for obtaining representative values or the number of lines from which representative values are to be obtained is changed, the following method will be changed to the appropriate method corresponding thereto. Also, the representative values A₁ to A₃ may be of any lines in the first region 102 and the second region 103.

In step S704, the characteristic value obtaining unit 601 calculates a characteristic value s₁ and a characteristic value s₂. The characteristic value s₁ and the characteristic value s₂ are defined as follows:

s₁=[A₂−A₁] (31)

s₂=[A₃−A₂] (32)

According to the above definition, the characteristic value s₁ shows a difference between a representative value of pixel values of the light shielded pixels in the first region 102, and a representative value of pixel values of light shielded pixels in the second region. Also, the characteristic value s₂ shows a difference between representative values of pixel values of light shielded pixels in the second region 103. In the third embodiment, as will be described below, a first determination method or a second determination method is applied depending on whether these characteristic values are a first threshold value or less, or a second threshold value or less.

Generally, a difference between representative values of the first region 102 and the second region 103 is larger than a difference between representative values in the second region 103. Therefore, the threshold value determination unit 602 first checks, in step S705, the characteristic value s₁, which is a difference between representative values of the first region 102 and the second region 103. For this check, a threshold value ε₁ is determined in advance. The first threshold value ε₁ is a characteristic value when a difference in the dark current value between the first region 102 and the second region 103 starts occurring in an image as an artifact. Note that such a first threshold value ε₁ can be obtained experimentally.

If the characteristic value s₁ is less than the first threshold value ε₁, it shows a case where a difference in the dark current value between the first region 102 and the second region 103 does not occur as an artifact. Accordingly, in step S706, the image subtracting unit 112 uses the same function between the first region 102 and the second region 103, to subtract output values of the function from the corresponding pixel values. That is, the same determination method between the first region 102 and the second region 103 can be used without distinguishing the representative values obtained in the first region 102 and the second region 103.

On the other hand, if it is determined in step S705 that the characteristic value s₁ is the first threshold value ε₁ or more, the procedure advances to step S707. In step S707, the threshold value determination unit 602 checks the characteristic value s₂, which is a difference between characteristic values in the second region 103. For this check, a second threshold value ε₂ is determined in advance. The second threshold value ε₂ is a threshold value for a characteristic value that reduces an artifact to the similar extent with respect to both the regions, when outputs of a curve is subtracted and when representative values of respective lines in both the first region and the second region are subtracted. Note that such a second threshold value ε₂ can be obtained experimentally.

If the characteristic value s₂ is a second threshold value ε₂ or less, the occurrence of an artifact is reduced when a representative value is subtracted from the pixel value in the first region 102, and an output value of a function is subtracted from the pixel value in the second region 103. Therefore, the procedure advances from step S707 to step S708, where the image subtracting unit 112 performs the correction of a dark current signal as described in the first embodiment. That is, a representative value is subtracted from the pixel value in the first region 102, and an output value of a function is subtracted from the pixel value in the second region 103.

On the other hand, if the characteristic value s₂ is the second threshold value ε₂ or more, the occurrence of an artifact is reduced when representative values of respective lines in both the first region 102 and the second region 103 are subtracted from the corresponding pixel values. Therefore, the procedure advances from step S707 to step S709, where the image subtracting unit 112 subtracts, for respective lines in both the first region 102 and the second region 103, a representative value of from pixel values. The above-described procedures are performed continuously until an image is completely obtained.

Note that, if a plurality of lines are included in the first region 102, the image subtracting unit 112 may operate, in step S708, as described in the second embodiment. That is, in step S708, the image subtracting unit 112 may subtract, with respect to the first region 102, an output value of the function derived for the first region 102 from the corresponding pixel value, and subtract, with respect to the second region 103, an output value of the function derived for the second region 103 from the corresponding pixel value.

According to the above-described third embodiment, a correction using an appropriate light shielded region can be used depending on an amount of an artifact, thus making it possible to obtain an image in which less artifact occurs as compared to the first embodiment and the second embodiment.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-040036, filed Feb. 28, 2013, which is hereby incorporated by reference herein in its entirety.

What is claimed is:

1. An imaging apparatus comprising an imaging element in which a plurality of pixels are arranged on a two-dimensional surface, the two-dimensional surface having a first region that includes one or more lines, and a second region other than the first region that includes a plurality of lines, each line including a light shielded region that is shielded from light, and an effective region other than the light shielded region, the imaging apparatus further comprising:
a derivation unit configured to derive, for each line, a representative value based on pixel values in the light shielded region;
a first determination unit configured to determine, based on the representative value derived with respect to the first region, a correction value for use in an offset correction for each line in the first region; and
a second determination unit configured to determine, based on the representative value derived with respect to the second region, a correction value for use in the offset correction for each line in the second region.

2. The imaging apparatus according to claim 1,
wherein the first determination unit determines a representative value derived for each line as the correction value, and
the second determination unit determines the correction value for each line by using a function for determining a correction value for a line based on a plurality of representative values including representative values of lines adjacent to that line.

3. The imaging apparatus according to claim 2,
wherein the function is an average of representative values in the second region, a moving average obtained based on representative values of adjacent lines, a median of representative values of adjacent lines, or a fitting curve obtained based on representative values of the second region.

4. The imaging apparatus according to claim 1,
wherein the first determination unit determines, with respect to each line in the first region, the correction value for that line with the use of a first function for determining a correction value for a line based on a plurality of representative values including representative values of lines adjacent to that line, and
the second determination unit determines, with respect to each line in the second region, the correction value for that line with the use of a second function for determining a correction value for a line based on a plurality of representative values including representative values of lines adjacent to that line.

5. The imaging apparatus according to claim 4,
wherein the first function is an average of representative values in the first region, a moving average obtained based on representative values of adjacent lines, a median of representative values of adjacent lines, or a fitting curve obtained based on representative values of the first region, and
the second function is an average of representative values of the second region, a moving average obtained based on representative values of adjacent lines, a median of representative values of adjacent lines, or a fitting curve obtained based on representative values of the second region.

6. The imaging apparatus according to claim 1,
wherein the first and second determination units use the same determination method between the first region and the second region without distinguishing therebetween, if a difference between the representative value obtained in the first region and the representative value obtained in the second region is a first threshold value or less.

7. The imaging apparatus according to claim 6,
wherein the same determination method determines the correction value with the use of the same function for determining a correction value for a line based on a plurality of representative values including representative values of lines adjacent to that line, the function involving smoothing.

8. The imaging apparatus according to claim 6,
wherein, if a difference between a plurality of representative values obtained in the second region exceeds a second threshold value, both the first determination unit and the second determination unit determine representative values derived for respective lines as the correction values.

9. The imaging apparatus according to claim 1,
wherein, if the light shielded region includes a defect pixel, the derivation unit determines a pixel value of the defect pixel by interpolation using pixels adjacent to the defect pixel and calculates a representative value based on the determined pixel value.

10. The imaging apparatus according to claim 1,
wherein, if the light shielded region includes a defect pixel, the derivation unit derives the representative value without using the defect pixel.

11. The imaging apparatus according to claim 1,
further comprising a correction unit configured to subtract the correction values for respective lines obtained by the first determination unit and the second determination unit from pixel values in the lines.

12. The imaging apparatus according to claim 1,
wherein the first region is constituted by a line in the vicinity of which a vertical scanning circuit is arranged.

13. A method for controlling an imaging apparatus including an imaging element in which a plurality of pixels are arranged on a two-dimensional surface, the two-dimensional surface having a first region that includes one or more lines, and a second region that is other than the first region and includes a plurality of lines, each line including a light shielded region that is shielded from light, and an effective region other than the light shielded region,
the method comprising:
a derivation step of deriving, for each line, a representative value based on pixel values in the light shielded region;
a first determination step of determining, based on the representative value derived with respect to the first region, a correction value for use in an offset correction for each line in the first region, the first determination step being performed according to a first determination method; and
a second determination step of determining, based on the representative value derived with respect to the second region, a correction value for use in the offset correction for each line in the second region, the second determination step being performed according to a second determination method that is independent from the first determination method.

14. A computer-readable storage medium having stored therein a program for causing a computer to execute the steps of the controlling method according to claim 13.
